(19) United States
(12) Patent Application Publication
(10) Pub. No.: US 2007/0063155 A1
(43) Pub. Date: Mar. 22, 2007

(54) Radiation image conversion panel and method of manufacturing same

(75) Inventor: Shinichiro Fukui, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/521,433

(22) Filed: Sep. 15, 2006

(30) Foreign Application Priority Data
Sep. 20, 2005 (JP) 2005-272829

(51) Int. Cl. G03B 42/08

(52) U.S. Cl. 250/484.4

(57) ABSTRACT

The invention provides a radiation image conversion panel having a substrate and a phosphor layer laminated on the substrate. A coating layer having at least one metal containing-layer is provided on a surface of the phosphor layer which is other than on the side which the substrate is laminated. The invention further provides a method for forming a radiation image conversion panel having a substrate and a phosphor layer laminated on the substrate, including forming, by a CVD method, a metal containing-layer on a surface of the phosphor layer which is other than on the side which the substrate is laminated.

### BACKGROUND OF THE INVENTION

1. Field of the Invention

The present invention relates to a radiation image conversion panel used for radiation image conversion methods using photostimulable phosphors and a method of manufacturing same.

2. Description of the Related Art

An imaging plate (IP) for dental applications is required to be sufficiently durable against scratching when handling, to a certain amount of water droplet adherence, and the like. Various studies have been made on such durable imaging plates for dental applications.

For preventing imaging plates from being deteriorated by adhesion of water droplets, a radiation image conversion panel have been proposed (for example, Japanese Patent Application Laid-Open (JP-A) No. 2004-12413), wherein edges of a photostimulable phosphor sheet and the surface of a support tray in the vicinity of the edge are sealed with a sealing member. In another radiation image conversion panel that has been proposed, the side faces of the imaging plate are coated with an adhesive resin layer and a cycloolefin copolymer in this order (for example JP-A No. 2004-294137). However, sufficient waterproofing has not been attained yet in these methods due to relatively high moisture permeability ascribed to thermal motion of the main chain and side chain of the organic polymer. By increasing the thickness of sealants to compensate for insufficient water proofing properties, there arises the problem of narrowing the imaging area and the like.

### SUMMARY OF THE INVENTION

The invention has been achieved in consideration of the problems described above.

Namely, the present invention provides a radiation image conversion panel having a substrate and a phosphor layer laminated on the substrate, wherein a coating layer having at least one metal containing-layer is provided on a surface of the phosphor layer which is other than on the side which the substrate is laminated.

It is preferable that the radiation image conversion panel of the present invention satisfies at least the conditions of the following embodiments (1) to (5).

Namely, in one preferable embodiment of the radiation image conversion panel of the present invention, (1) the metal-containing layer comprises at least one of a metal oxide or a metal nitride.

In another preferable embodiment of the radiation image conversion panel of the present invention, (2) the metal-containing layer comprises at least one of silicon oxide, silicon nitride, silicon oxide nitride and aluminum oxide.

In another preferable embodiment of the radiation image conversion panel of the present invention, (3) the coating layer comprises the metal-containing layer and a resin layer, and the resin layer and the metal-containing layer are sequentially formed in this order on a surface of the phosphor layer which is other than on the side which the substrate is laminated.

In another preferable embodiment of the radiation image conversion panel of the present invention, (4) the metal-containing layer is formed by a CVD (Chemical Vapor Deposition) method.

Further, in still another preferable embodiment of the radiation image conversion panel of the present invention, (5) the metal-containing layer is formed by a plasma CVD method.

The present invention furthermore provides a method for forming a radiation image conversion panel having a substrate and a phosphor layer laminated on the substrate, comprising forming, by a CVD method, a metal containing-layer on a surface of the phosphor layer which is other than on the side which the substrate is laminated. The CVD method preferably comprises forming the metal containing-layer at a single time on the entire surface of the phosphor layer which is other than on the side which the substrate is laminated.

### BRIEF DESCRIPTION OF THE DRAWING

FIG. 1 shows a partial cross section of the layer constitution of a radiation image conversion panel of the invention.

### DETAILED DESCRIPTION OF THE INVENTION

Radiation Image Conversion Panel

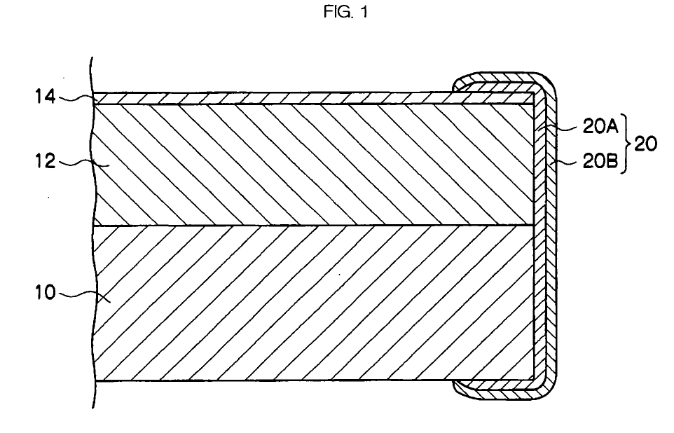

FIG. 1 shows a partial cross section of the layer constitution of a radiation image conversion panel of the invention. As shown in FIG. 1, the radiation image conversion panel of the invention comprises a phosphor layer 12 and a protective layer 14 sequentially formed on a substrate 10. A coating layer 20 comprising a resin layer 20A and a metal-containing layer 20B is formed at the side face of the phosphor layer 12, that is not the face that is laminated. While sufficient waterproofing effect cannot be obtained by the resin layer 20A alone, a high waterproofing effect may be manifested by providing the metal-containing layer 20B, since a dense film having few defects is obtained. A sufficient waterproof effect may be obtained even by providing the metal-containing layer 20B alone.

The metal-containing layer 20B preferably contains at least one of a metal oxide or a metal nitride, from the view point of chemical and physical stability and denseness of the film. The range of metals available in the invention for the metal-containing layer 20B includes Si.

Examples of the metal oxide and metal nitride include aluminum nitride, zirconium oxide, tin oxide, aluminum oxide nitride, silicon oxide, silicon nitride, silicon oxide nitride and aluminum oxide. The material is preferably at least one of silicon oxide, silicon nitride, silicon oxide nitride and aluminum oxide from the view point of denseness and cost of the film.

The average thickness of the metal-containing layer 20B is preferably in the range from 0.001 to 1.0 μm, more preferably in the range from 0.01 to 0.5 μm. The metal-containing layer 20B may be formed as plural layers in the coating layer 20. The average of the combined thickness of the layers is preferably within the above-described range when pluralities of the metal-containing layers are formed.

The metal-containing layer 20B is preferably formed by a CVD method, particularly by a plasma CVD method, from the view point of forming a dense film. Details of the CVD method will be described later.

While the resin layer 20A in the coating layer 20 may be optionally formed, it is preferably provided for permitting the metal-containing layer to be readily formed and for improving adhesiveness. The average thickness of the resin layer 20a is preferably in the range from 0.1 to 100 μm, more preferably in the range form 1 to 50 μm. Plural resin layers 20A may be formed in the coating layer 20. The average combined thickness of plural layers is preferably within the above range, when plural resin layers are formed.

Examples of the resin in the resin layer 20A include polyester, polyurethane, silicone resin, fluorinated resin, acrylic resin, cycloolefin resin, polyvinyl alcohol, and copolymers thereof.

The area over which the coating layer is formed is at least a surface of the phosphor layer that is not on the laminated side (particularly on a not laminated surface). The term “not laminated surface” of the phosphor layer as used herein refers to a surface on which no layers are formed on the phosphor layer, namely the side edge face(s) of the phosphor layer, in a case where the layer constitution is as shown in FIG. 1. When no protective layer is formed on the phosphor layer, the term “not laminated” surface of the phosphor layer refers to the side edge face(s) and to the surface on the opposite side of the phosphor layer to the surface on which the substrate is formed (that is the top surface).

The material of each layer constituting the radiation image conversion panel of the invention will be described below.

Examples of the favorable material used for the substrate include PET, polycycloolefins, PEN (polyethylene naphthalate), PVAs (polyvinyl alcohols), nano-alloy polymers of PET and PEI (polyether imide) and transparent aramids. Preferable examples include these materials having a glass transition temperature of 85° C. or more, more preferably 100° C. or more. In particular, preferable examples include those comprising the materials such as nano-alloy polymers of polycycloolefins, PEN (polyethylene naphthalate), PVAs (polyvinyl alcohols), nano-alloy polymers of PET and PEI, and transparent aramids, that have a glass transition temperature of 85° C. or more. Examples of further preferable materials include polycycloolefins, PEN (polyethylene naphthalate), nano-alloy polymers of PET and PEI (polyether imide) and transparent aramids, that have a glass transition temperature of 100° C. or more.

Phosphor Layer

A preferable example of the photostimulable phosphor used for the phosphor layer include a photostimulable phosphor represented by the Formula (M_{1-f}.M_{f}^{I})X.bM^{III}X3″:cA (Formula I). Rb, Cs, Na containing Cs, and/or K containing Cs are preferable as M^{I} in Formula (I) from the view point of photostimulable luminance, and at least one alkali metal selected from Rb and Cs is particularly preferable. At least one trivalent metal selected from Y, La, Lu, Al, Ga and In is preferable as M^{III}. At least one halogen selected from F, Cl and Br is preferable as X″. The b-value representing the content of M^{III}X3″ is preferably selected in the range of 0≦b≦10⁻².

An activator A in Formula (I) is preferably at least one metal selected from Eu, Tb, Ce, Tm, Dy, Ho, Gd, Sm, Tl and Na, and at least one metal selected from Eu, Ce, Sm, Tl and Na is particularly preferable. The c-value representing the content of the activator is preferable selected in the range of 10⁻⁶<c<0.1 from the view point of photostimulable luminance.

Examples of the photostimulable phosphor includes as follows:

SrS:Ce,Sm; SrS:Eu,Sm; ThO₂:Er; and La₂O₂S:Eu,Sm; described in U.S. Pat. No. 3,859,527;

a phosphor represented by composition formulae of ZnS:Cu,Pb; BaO.xAl₂O₃:Eu (0.8≦x≦10); and M^{II}O.xSiO₂:A (M^{II} represents Mg, Ca, Sr, Zn, Cd or Ba; A represents Ce, Tb, Eu, Tm, Pb, Tl, Bi or Mn; and x is in the range of 0.5≦x≦2.5) described in JP-A No. 55-12142;

a phosphor represented by a composition formula of (Ba_{1-x-y}, Mgₓ, Ca_{y})FX:aEu²⁺ (X is at least one of Cl and Br; x and y satisfy the relations of 0<x+y≦0.6 and xy≠0; and a is in the range of 10⁻⁶≦a≦5×10⁻²) described in JP-A No. 55-12143;

a phosphor represented by a composition formula of LnOX:xA (Ln represents at least one of La, Y, Gd and Lu; X represents at least one of Cl and Br; A represents at least one of Ce and Tb; and x is in the range of 0<x<0.1) described in JP-A No. 55-12144;

a phosphor represented by a composition formula of (Ba₁₋ₓ,M^{II}ₓ)FX:yA (M^{II} represents at least one of Mg, Ca, Sr, Zn and Cd; X represents at least one of Cl, Br and I; A represents at least one of Eu, Tb, Ce, Tm, Dy, Pr, Ho, Nd, Yb and Er; and x is in the range of 0≦x≦0.6 and 0≦y≦0.2) described in JP-A No. 55-12145;

a phosphor represented by a composition formula of M^{II}FX.xA:yLn (M^{II} represents at least one of Ba, Ca, Sr, Mg, Zn and Cd; A represents at least one of BeO, MgO, CaO, SrO, BaO, ZnO, Al₂O₃, Y₂O₃, La₂O₃, In₂O₃, SiO₂, TiO₂, ZrO₂, GeO₂, SnO₂, Nb₂O₅, Ta₂O₅ and ThO₂; Ln represents at least one of Eu, Tb, Ce, Tm, Dy, Pr, Ho, Nd, Yb, Er, Sm and Gd; X represents at least one of Cl, Br and I; and x and y are in the ranges of 5×10⁻⁵≦x≦0.5 and 0<y≦0.2, respectively) described in JP-A No. 55-160078;

a phosphor represented by a composition formula of (Ba₁₋ₓ,Mn^{II}ₓ)F₂.aBaX₂:yEu,zA (Mn^{II} represents at least one of Be, Mg, Ca, Sr, Zn and Cd; X represents at least one of Cl, Br and I; A represents at least one of Zr and Sc; and a, x, y and z are in the ranges of 0.5≦a≦1.25, 0≦x 1, 10⁻⁶≦y≦2×10⁻¹ and 0<z≦10⁻², respectively) described in JP-ANo. 56-116777;

a phosphor represented by a composition formula of (Ba₁₋ₓ,Mn^{II}ₓ)F₂.aBaX₂:yEu,zB (Mn^{II} represents at least one of Be, Mg, Ca, Sr, Zn and Cd; X represents at least one of Cl, Br and I; and a, x, y and z are in the ranges of 0.5≦a≦1.25, 0≦x 1, 10⁻⁶≦y≦2×10⁻¹ and 0<z≦10⁻², respectively) described in JP-A No. 57-23673;

a phosphor represented by a composition formula of (Ba₁₋ₓ,Mn^{II}ₓ)F₂.aBaX₂:yEu,zA (Mn^{II} represents at least one of Be, Mg, Ca, Sr, Zn and Cd; X represents at least one of Cl, Br and I; A represents at least one of Ar and Si; and a, x, y and z are in the ranges of 0.5≦a≦1.25, 0≦x 1, 10⁻⁶≦y≦2×10⁻¹ and 0<z≦5×10⁻³, respectively) described in JP-A No. 57-23675;

a phosphor represented by a composition formula of M^{III}OX:xCe (M^{III} represents at least one trivalent metal selected from a group consisting of Pr, Nd, Pm, Sm, Eu, Tb, Dy, Ho, Er, Tm, Yb and Bi; X represents any one or both of Cl and Br; and x is in the range of 0<x<0.1) described in JP-A No. 58-69281;

a phosphor represented by a composition formula of Ba₁₋ₓM_{x/2}L_{x/2}FX:yEu²⁺ (M represents at least one alkali metal selected from a group consisting of Li, Na, K, Rb and Cs; L represents at least one trivalent metal selected from a group consisting of Sc, Y, La, Ce, Pr, Nd, Pm, Sm, Gd, Tb, Dy, Ho, Er, Tm, Yb, Lu, Al, Ga, In and Tl; X represents at least one halogen selected from a group consisting of Cl, Br and I; and x and y are in the ranges of 10⁻²≦x≦0.5 and 0<y≦0.1, respectively) described in JP-ANo. 58-206678;

a phosphor represented by a composition formula of BaFX xA:yEu²⁺ (X represents at least one halogen selected from a group consisting of Cl, Br and I; A is a sintered body of a tetrafluoroboric acid compound; and x and y are in the ranges of 10⁻⁶≦x≦0.1 and 0<y≦0.1, respectively) described in JP-A No. 59-27980;

a phosphor represented by a composition formula of BaFX.xA: yEu²⁺ (X represents at least one halogen selected from a group consisting of Cl, Br and I; A is a sintered body of a compound selected from a group of hexafluoro compound comprising monovalent or divalent metal salts of hexafluorosilicic acid, hexafluorotitanic acid and hexafluorozirconic acid; and x and y are in the ranges of 10⁻⁶≦x≦0.1 and 0<y≦0.1, respectively) described in JP-A No. 59-47289;

a phosphor represented by a composition formula of BaFX.xNaX′:aEu²⁺ (X and X′ represent at least one of Cl, Br and I, respectively; and x and a are in the ranges of 0<x≦2 and 0<a≦0.2, respectively) described in JP-A No. 59-56479;

a phosphor represented by a composition formula of M^{II}FX.xNaX′:yEu²⁺:zA (M^{II} represents at least one alkali earth metal selected from a group consisting of Ba, Sr and Ca; X and X′ represent at least one halogen selected from a group consisting of Cl, Br and I; A represents at least one transition metal selected from a group consisting of V, Cr, Mn, Fe, Co and Ni; and x, y and z are in the ranges of 0<x≦2, 0<y≦0.2 and 0<z≦10⁻², respectively) described in JP-A No. 59-56480;

a phosphor represented by a composition formula of M^{II}FX.aM¹X′b.M′^{II}X″₂.cM^{III}x′″₃.xA:yEu²⁺ (M^{II} represents at least one alkali earth metal selected from a group consisting of Ba, Sr and Ca; M′^{II} represents at least one alkali metal selected from a group consisting of Li, Na, K, Rb and Cs; M^{I} represents at least one divalent metal selected from a group consisting of Be and Mg; M^{III} represents at least one trivalent metal selected from a group consisting of Al, Ga, In and Tl; A represents a metal oxide; X represents at least one halogen selected from a group consisting of Cl, Br and I; X, X″ and X′″ represent at least one halogen atom selected from a group consisting of F, Cl, Br and I; a, b and c are in the ranges of 0≦a≦2, 0≦b≦10⁻² and 0≦c≦10⁻², respectively, with a relation of a+b+c≧10⁻⁶; and x and y are in the ranges of 0<x≦0.5 and 0<y≦0.2, respectively) described in JP-ANo. 59-75200;

a photostimulable phosphor represented by a composition formula of M^{II}X₂.aM^{II}X′₂:xEu²⁺ (M^{II} represents at least one alkali earth metal selected from a group consisting of Ba, Sr and Ca; X and X′ are at least one halogen selected from a group consisting of Cl, Br and I with X≠X′; a is in the range of 0.1≦a≦10.0, and x is in the range of 0<x≦0.2) described in JP-A No. 60-84381;

a photostimulable phosphor represented by a composition formula of M^{II}FX.aM^{I}X′:xEu²⁺ (represents at least one alkali earth metal selected from a group consisting of Ba, Sr and Ca; M^{I} represents at least one alkali metal selected from a group consisting of Rb and Cs; X represents at least one halogen selected from a group consisting of Cl, Br and I; X′ represents at least one halogen selected from a group consisting of F, Cl, Br and I; and a and x are in the ranges of 0≦a≦4.0 and 0<x≦0.2, respectively) described in JP-A No. 60-101173;

a photostimulable phosphor represented by a composition formula of M^{I}X:xBi (M^{I} represents at least one alkali metal selected from a group consisting of Rb and Cs; X represents at least one halogen selected from a group consisting of Cl, Br and I; and x is in the range of 0<x≦0.2) described in JP-A No. 62-25189; and

a phosphor of cerium-activated oxyhalogenated rare earth represented by LnOX:xCe (Ln represents at least one of La, Y, Gd and Lu; X represents at least one of Cl, Br and I; x is in the range of 0<x≦0.2; the ratio between Ln and X is in the range of 0.500<X/Ln≦0.998; and the maximum wavelength of the photostimulable excitation spectrum is in the range of 550 nm<λ<700 nm) described in JP-A No 2-229882.

Additives shown below may be contained in the photostimulable phosphor represented by M^{II}X₂.aM^{II}X′₂:xEu²⁺ described in JP-A No. 60-84381:

bM^{I}X″ (M^{I} represents at least one alkali metal selected from a group consisting of Rb and Cs; X″ represents at least one halogen selected from a group consisting of F, Cl, Br and I; and b is on the range of 0<b≦10.0) described in JP-A No. 60-166379; bKX″.cMgX₂.dM^{III}X′₃ (M^{III} represents at least one trivalent metal selected from a group consisting of Sc, Y, La, Gd and Lu; X″, X and X′ each represents at least one halogen atom selected from a group consisting of F, Cl, Br and I; and b, c and d are in the ranges of 0≦b≦2.0, 0≦c≦2.0 and 0≦d≦2.0, respectively, with a relation of 2×10⁻⁵≦b; +c+d) described in JP-A No. 60-221483; yB (y is in the range of 2×10⁻⁴≦y≦2×10⁻¹) described in JP-A No. 60-228592; bA (A represents at least one oxide selected from a group consisting of SiO₂ and P₂O₅; and b is in the range of 10⁻⁴≦b≦2×10⁻¹) described in JP-A No. 60-228593; bSiO (b is in the range of o<b≦3×10⁻²) described in JP-A No. 61-120883; bSnX″₂ (X″ represents at least one halogen selected from a group consisting of F, Cl, Br and I; and b is in the range of 0<b≦10⁻³) described in JP-A No. 61-120885; bCsX″.cSnX₂ (X″ and X each is at least one halogen selected from a group consisting of F, Cl, Br and I; and b and c are in the ranges of 0<b≦10.0 and 10⁻⁶≦c≦2×10⁻², respectively) described in JP-A No. 61-235486; and bCsX″.yLn³⁺ (X″ represents at least one halogen selected from a group consisting of F, Cl, Br and I; Ln represents at least one rare earth element selected from a group consisting of Sc, Y, Ce, Pr, Nd, Sm, Gd, Tb, Dy, Ho, Er, Tm, Yb and Lu; and b and y are in the ranges of 0<b≦10.0 and 10⁻⁶≦y≦1.8×10⁻¹, respectively) described in JP-A No. 61-235487.

Of the photostimulable phosphors, a phosphor of a fluorinated halide of an alkali earth metal activated with divalent europium (for example BaFI:Eu), a phosphor of an alkali metal halide activated with europium (for example CsBr:Eu), a phosphor of alkali earth halide activated with divalent europium containing iodine, a phosphor of rare earth oxyhalide activated with a rare earth element containing iodine, and a phosphor of alkali metal halide activated with bismuth containing iodine can be favorably used since these compounds exhibit photostimulable light emission with high luminance.

Protective Layer and Back Layer

Examples of the protective layer formed on the phosphor layer include a protective layer formed by applying a solution prepared by dissolving a transparent organic polymer substance, such as a cellulose derivative or methyl polymethacrylate, onto a phosphor layer; a protective layer provided by bonding an organic polymer film such as a polyethylene terephthalate film or a protective film-forming sheet such as a transparent glass sheet, which are separately formed, onto the surface of the phosphor layer using an appropriate adhesive; and a protective layer formed by depositing an inorganic compound on the phosphor layer by vacuum deposition or the like.

Another example of the protective layer includes a protective layer comprising a coating film of an organic solvent-soluble fluorinated resin, in which fine particles of a perfluoroolefin resin powder or silicon resin powder or the like are dispersed.

A back layer may be formed on the back surface of substrate, opposite to the side on which the phosphor layer is formed, in order to endow the imaging panel with chemical and physical durability and transportability. Examples of materials of the back layer include polyolefin resins, polyester resins, acrylic resins, metals (foils or particles) and paper sheet. The back layer may be formed, for example, by lamination, press bonding, heat fusion, coating or vacuum deposition.

Intermediate Layer

The intermediate layer serves as an adhesive layer for improving adhesiveness between the phosphor layer and substrate, and is provided as appropriate. Examples of materials for forming the intermediate layer include cellulose derivatives such as cellulose acetate and nitrocellulose; and transparent polymer materials such as synthetic polymer substances including methyl polymethacrylate, polyvinyl butyral, polyvinyl formal, polycarbonate, polyvinyl acetate, polyvinyl chloride-polyvinyl acetate copolymers, fluorinated resins, polyethylene, polypropylene, polyester, acrylic resin, polyparaxylylene, PET, and chlorinated rubber and polyvinylidene chloride copolymers. These synthetic polymer substances that form the intermediate layer may be used either as a polymer or as a monomer. The substance is preferably cross-linked by heat or irradiation with visible light, UV light, electron beams or the like.

When an intermediate layer is formed on the substrate, it is preferable to add a coupling agent such as a silane coupling agent and titanate coupling agent to the composition of the intermediate layer for improving adhesiveness. Various additives can be used for improve the coatability of the intermediate layer composition and properties of the thin film after hardening, and for endow the coating film with photosensitivity, depending on the purpose. Such examples are various polymers and monomers having hydroxyl groups, colorants such as pigments and dyes, anti-yellowing agents, stabilizers such as anti-aging agents and UV absorbents, thermal acid generators, photo-acid generators, surfactants, solvents, cross-linking agents, hardening agents and polymerization inhibiting agents.

The intermediate layer may contain an organic or inorganic powder for improving durability and for preventing iridescent blemishes. The content of the powder is preferably about 0.5 to 60% by weight per unit weight of the intermediate layer. Favorable examples of the powder include a powder that absorbs a specified color band (for example ultramarine), and a white powder that does not have particular absorption wavelengths in the wavelength region of from 300 to 900 nm. The volume average particle diameter of the powder is preferably in the range from 0.01 to 10 μm, more preferably about 0.3 to 3 μm. While the particle size of these powders usually has a given distribution range, the narrower the distribution range is, the more preferable.

Method for Manufacturing the Radiation Image Conversion Panel

The invention further provides a method for manufacturing the radiation image conversion panel having at least forming a metal-containing layer that contains metal using a CVD method at a not laminated surface of the phosphor layer. The method for manufacturing the radiation image conversion panel is not particularly restricted, so long as the method comprises a CVD process.

An examples of the method for manufacturing the radiation image conversion panel of the invention comprises: forming an intermediate layer (optional) on a substrate; applying a phosphor material onto a temporary substrate then peeling the phosphor material from the temporary substrate to manufacture a phosphor sheet comprising a phosphor material; forming a phosphor layer by bonding the phosphor sheet onto the intermediate layer; and cutting the substrate on which the phosphor layer is bonded to the desired size. Since the CVD process is used for providing a metal-containing layer on a surface of the phosphor layer that is not the side that has been laminated, the CVD process is preferably provided after manufacturing the phosphor sheet, forming the phosphor layer, and cutting the substrate.

Chemical Vapor Deposition (CVD) Process

The metal-containing layer is provided on a surface of the phosphor layer that is not the laminated side by a CVD (Chemical Vapor Deposition) method. The layer is formed by depositing particles at the molecular level by a CVD method. Accordingly, a denser film than films formed by coating or sputtering can be formed. Examples of CVD methods include thermal CVD methods by which the metal is deposited by heating a substrate (supporting base), photo-CVD methods in which light is irradiated for promoting a chemical reaction or heat decomposition, and plasma CVD methods for exciting a gas into a plasma state. Among these a plasma CVD method is preferably used since a denser film can be formed by reducing cracks and micro-pores from being formed.

When the metal-containing layer is formed by a thermal CVD method, preferable conditions of the method are as follows. The in-flow rate of a material gas into the apparatus is preferably controlled to be about 10 to 10,000 ml/min, and the pressure in the apparatus is preferably adjusted to be 1 to 10⁶ Pa. Examples of the gas material include silane, disilane, ammonia, trimethyl aluminum, nitrogen and oxygen, although it depends on the material of the metal-containing layer to be formed. The temperature of the substrate in the apparatus is preferably in the range form 50 to 200° C.

When the metal-containing layer is formed by a plasma CVD method, preferable conditions of the method are as follows. The in-flow rate of a material gas into the apparatus is preferably controlled to be about 10 to 10,000 ml/min, and the pressure in the apparatus is preferably adjusted to be 1 to 10⁶ Pa. Examples of the gas material include silane, disilane, ammonia, trimethyl aluminum, nitrogen and oxygen, although it depends on the material of the metal-containing layer to be formed. The temperature of the substrate in the apparatus is preferably 0 to 200° C. High frequency power with a frequency in the range from 10⁻⁴ to 10 MHz is applied to a discharge electrode for generating plasma.

Such a metal-containing layer formed through a CVD process as above is excellent in water proofing since it is a dense film with fewer cracks, fissures and point defects.

It is preferable to form a resin layer in at least the area where the metal-containing layer is to be formed before forming the metal-containing layer. Examples of materials of the resin layer are as described above. Applicable examples for forming the metal-containing layer include dip methods, brushing methods and spray methods. The metal-containing layer and resin layer may be selectively formed on only the desired area by using a mask as appropriate. In the CVD process it is preferable, from the view point of productivity, to form the metal-containing layer over the entire surfaces that are not the lamination sides at one time.

Formation of Intermediate Layer

The intermediate layer is formed on the substrate by an intermediate layer forming process for enhancing adhesiveness between the substrate and phosphor layer. A dispersion solution for forming the intermediate layer is applied onto the substrate by a doctor blade, knife coater or bar coater method. Then, the intermediate layer is formed by drying the coating solution at a temperature in the range from 50 to 200° C. The thickness of the intermediate layer is preferably in the range from 1 to 200 μm.

The dispersion solution for forming the intermediate layer can be prepared by dissolving a binder and plasticizer in a solvent. Examples of the binder available include the polymer substances. Examples of the plasticizer available include phthalic acid ester, adipic acid ester and polyester plasticizer. Examples of the solvent include ketone-base organic solvents such as methylethyl ketone, ester-base organic solvents and aromatic organic solvents.

Manufacturing of Phosphor Sheet

This process comprises forming a layer comprising a photostimulable phosphor material on the temporary substrate, and forming the phosphor sheet containing the phosphor material by peeling a layer thereof from the temporary substrate.

The phosphor layer may be formed on the temporary substrate by known methods such as vacuum deposition, sputtering and coating methods.

In vacuum deposition methods, the inside of the apparatus is evacuated to a vacuum of about 10⁻⁴ Pa after placing a temporary substrate in the vacuum deposition apparatus. Then, at least one photostimulable phosphors is evaporated by resistance heating or electron beam heating to cause the photostimulable phosphor to deposit on the temporary substrate at the desired thickness. The phosphor layer may be formed by dividing the vacuum deposition process into several processes. The phosphor layer may be simultaneously formed while the desired photostimulable phosphor is synthesized, by co-depositing using plural resistance heaters or electron beams for the depositing. The phosphor layer may be heat-treated after completing the vacuum deposition.

In sputtering methods, the inside of the apparatus is also evacuated to a vacuum of about 10⁻⁴ Pa after placing a temporary substrate in the sputtering apparatus as in the vacuum deposition method, and the gas pressure is adjusted to about 10⁻¹ Pa by introducing an inert gas such as Ar and Ne as a sputtering gas. Then, the photostimulable phosphor is caused to deposit on the surface of the temporary substrate at a desired thickness using the photostimulable phosphor as a target. The phosphor layer may be formed by dividing the sputtering process into several processes of sputtering, as in the vacuum deposition. Further, the phosphor layer may be formed by simultaneously or sequentially sputtering plural targets each comprising a different photostimulable phosphor. Reactive sputtering is possible in the sputtering method by introducing reactive gases, such as O₂, H₂ and halogen, as necessary. The phosphor layer may be heat treated after completing the sputtering.

A coating film is formed in the coating method by preparing a coating solution in which the photostimulable phosphor is homogeneously dispersed by thoroughly mixing the phosphor with the solvent, and the coating film is formed by evenly applying the coating solution on the surface of the substrate. Conventional coating means, such as doctor blade, roll coater and knife coater, may be used for the coating.

When the phosphor layer is formed by a coating method, the phosphor layer contains the photostimulable phosphor and a binder that maintains the phosphor in a state of dispersion. Additives such as a colorant may be added to the phosphor layer. The phosphor layer can be formed on the temporary substrate by known methods as described below.

The photostimulable phosphor and binder are added to a solvent, and a coating solution in which the photostimulable phosphor is uniformly dispersed in the binder solvent is prepared by thoroughly mixing the solution. While the mixing ratio between the binder and photostimulable phosphor in the coating solution differs depending on the characteristics of the desired radiation image conversion panel and the kind of the photostimulable phosphor, the mixing ratio (mass ratio) of the binder to the photostimulable phosphor is selected in the range from 1:1 to 1:100, and preferably in the range from 1:8 to 1:40.

Examples of the binder include proteins such as gelatin; natural polymer compounds such as gum Arabic; and synthetic polymers such as polyvinyl butyral, polyvinyl acetate, nitrocellulose, ethyl cellulose, vinylidene chloride-vinyl chloride copolymer, methyl polymethacrylate, vinyl chloride-vinyl acetate copolymer, polyurethane, cellulose acetate butyrate, polyvinyl alcohol and linear polyester.

Examples of the solvent for preparing the coating solution include lower alcohols such as methanol, ethanol, propanol and butanol; chlorine atom-containing hydrocarbon such as methylene chloride and ethylene chloride; ketones such as acetone, methylethyl ketone and methylisobutyl ketone; esters of lower fatty acids and lower alcohols such as methyl acetate, ethyl acetate and butyl acetate; ethers such as dioxane and ethyleneglycol monoethylether; and mixtures of plural of these solvents. Known dispersing agents, plasticizers and yellowing preventives may be added, as necessary.

The thickness of the phosphor layer is different depending on the characteristics of the desired radiation image conversion panel, the kind of the phosphor, and the mixing ratio between the binder and phosphor, and is usually in the range from 20 μm to 1 mm. However, a thickness in the range from 50 μm to 500 μm is more preferable. A peelable film, having a fluorinated resin or silicone resin applied on at least one surface thereof, may be used as the temporary substrate.

Formation of Phosphor Layer

The phosphor layer is formed by bonding the phosphor sheet onto the intermediate layer in this process. Pressure is preferably applied in bonding process. The surface of the radiation image conversion panel can be hardened by bonding while applying pressure. A favorable example of bonding with a pressing treatment is bonding by calender treatment.

The pressure for applying calender treatment is preferably in the range from 1 to 100 Pa, since adhesion strength may be increased and yet the deterioration of the particular characteristics is suppressed by applying pressure in the range from 1 to 100 Pa. The roll temperature is preferably in the range from 25 to 200° C., since adhesion strength may be increased while suppressing degeneration of each layer by heating at a temperature the range from 25 to 200° C. The roll feed speed is preferably in the range from 0.1 to 100 m/min, since productivity and uniform quality can be made to be compatible by employing a roll feed speed of 0.1 to 100 m/min.

Cutting

The radiation image conversion panel is formed into a desired shape by punching using male and female cutters in the cutting process.

In addition to the processes described above, various other processes, such as a process for forming a protective layer, may be provided. Methods for sequentially forming layers may be employed for forming the phosphor layer and protective layer on the substrate, other than the embodiment as hitherto described. The CVD process is provided after the formation of the phosphor layer in this case.

### EXAMPLES

### Example 1

Formation of Intermediate Layer

A dispersion solution for forming an intermediate layer (viscosity: 0.6 Pa·s (20° C.)) was prepared by: by adding 3400 g of soft acrylic resin (trade name: CRYSCOAT P-1018GS (21% toluene solution), manufactured by Dainippon Ink and Chemicals, Inc.) as a binder and 120 g of phthalic acid ester (trade name: #10, manufactured by Daihachi Chemical Industry Co., Ltd.) as a plasticizer into 3600 g of methylethyl ketone and mixing; and dispersing and dissolving using a disperser.

This dispersion solution for forming the intermediate layer was uniformly applied on a substrate (carbon-kneaded polyethylene terephthalate (trade name: X-30, manufactured by Toray Industries Inc., thickness: 188 μm)) to form a coating film and dried. The intermediate layer with a thickness of 20 μm was thus formed.

Formation of Phosphor Sheet

A phosphor sheet that serves as a phosphor layer was prepared as follows. A coating solution with a viscosity of 4.0 Pa·s (25° C.) for forming the phosphor sheet was prepared by adding 1000 g of phosphors (BaFBr_{0.85}I_{0.15}:Eu²⁺, median diameter 3.5 μm), 36 g of polyurethane elastomer (trade name: PANDEX T5265H, manufactured by Dainippon Ink and Chemicals, Inc.) as a binder, 4 g of polyisocyanate (trade name: CORONATE HX (solid fraction 100%), manufactured by Nippon Polyurethane Industry Co., Ltd.) as a cross-linking agent, 10 g of an epoxy resin (trade name: #1001 EPICOAT, manufactured by Yuka-Shell Epoxy Co., solid form) as an anti-yellowing agent, and 2 g of ultramarine (trade name: SM-1, manufactured by Daiichi Kasei Co.) as a colorant, to 120 g of a mixed solvent of methylethyl ketone and butyl acetate (methylethyl ketone/butyl acetate (mass ratio)=6/4), and by dispersing at a blade rotation speed of 2500 rpm using a disperser for one minute. The colorant used was dispersed with a ball mill in a solvent in which a resin was added in advance.

This coating solution was uniformly applied on a temporary substrate (polyethylene terephthalate coated with a silicone release agent with a thickness of 180 μm) and, after drying, a phosphor sheet (thickness 150 μm) was prepared by peeling it from the temporary substrate.

Subsequently, the surface of the phosphor sheet peeled from the temporary substrate was laminated onto the intermediate layer by continuous compression at a pressure of 60 MPa with a roll temperature of 50° C. and a feed speed of 1.0 m/min using a calender roll. The phosphor sheet was tightly adhered onto substrate, with the intermediate layer interposed, by the pressing and heating, and the phosphor layer was formed on the substrate.

Cutting

A stretched polypropylene film (referred to as PP film hereinafter) with a thickness of 25 μm having an adhesive layer (the amount of coating of the adhesive: 3 g/m²) was prepared by coating with a solution of an unsaturated polyester resin (trade name: VYLON® 30SS, manufactured by Toyobo Co.) followed by drying. The surface of the substrate at the side on which no phosphor layer is formed was laminated onto the PP film with the adhesive layer of the PP film contacting the substrate, and the substrate was bonded to the PP film using a laminating roll to form a sheet having a back face layer.

Subsequently, this sheet was punched into an appropriate size (a square shape of 3 cm×3 cm) using punching blades (male and female cutters).

CVD Process

After cutting, a resin layer, as a coating layer, was formed by a dipping method on the surfaces of the phosphor layer not on the laminated side (the surfaces not contacting the substrate) of the sheet. The resin used for forming the resin layer was a polyester resin with an average thickness of the layer of 3 μm. Then, a metal-containing layer (SiON layer, average thickness 0.2 μm) as a coating layer was formed on the surface of the resin layer by thermal CVD. The thermal CVD conditions were as follows.

(1) Flow rate and material gas: SiH₄: 100 cc/min, NH₃: 600 cc/min, trace amount of oxygen gas

(2) Pressure in the apparatus: 105 Pa

(3) Temperature: 50° C.

The radiation image conversion panel according to Example 1 was manufactured through the above processes.

### Example 2

After forming a phosphor layer by the same method as in Example 1, a protective layer was formed on the phosphor layer as follows. A polyethylene terephthalate film (referred to as PET film hereinafter) with a thickness of 6 μm, on which an adhesive layer (an amount of coating of the adhesive: 2 g/m²) had been formed by applying a solution of an unsaturated polyester resin (trade name: VYLON® 30SS, manufactured by Toyobo Co.), was laminated onto the substrate on which the phosphor layer was formed, with the phosphor layer of the substrate contacting the adhesive layer of the PET film. The substrate and the PET film were bonded using a laminating roll, and the protective layer was formed by further processing with an embossing roll.

After forming the protective layer, sheets were prepared through the same cutting process as in Example 1. A resin layer (with a thickness of 2 μm) was formed on the phosphor layer on the not laminated side (the side edge face) by the same method as in Example 1. A metal-containing layer (SiON layer with an average thickness of 0.15 μm) was formed on the resin layer by a plasma CVD method under the following treatment conditions while plasma was generated using an inductive-coupling plasma apparatus.

(1) Flow rate and material gas: SiH₄: 100 cc/min, NH₃: 600 cc/min, trace amount of oxygen gas

(2) Pressure in the apparatus: 10⁵ Pa

(3) Temperature: 50° C.

The radiation image conversion panel according to Example 2 was manufactured through the processes as described above.

### Example 3

A radiation image conversion panel was manufactured by the same method as in Example 2, except that a further metal-containing layer (with an average thickness of 0.2 μm) comprising SiN was further formed on the metal-containing layer. The conditions for forming the metal-containing layer comprising SiN were as follows.

(1) Flow rate and material gas: SiH₄: 100 cc/min, NH₃: 600 cc/min

(2) Pressure in the apparatus: 10⁵ Pa

(3) Temperature: 50° C.

### Example 4

A radiation image conversion panel was manufactured by the same method as in Example 2, except that a resin layer comprising a silicone layer having an average thickness of 10 μm was further formed on the metal-containing layer.

### Example 5

Sheets were prepared by the same method as in Example 2 through a cutting process after forming the protective layer. Then masking was carried out by bonding a peelable adhesive film onto the protective layer, while leaving a region having a width of 1 mm from the edge. The masked sheet was mounted to a vacuum deposition apparatus (manufactured by ULVAC Inc.). A metal-containing layer (SiO₂ layer, average thickness 100 nm) as a coating layer was formed by DC magnetron sputtering using the apparatus. Then, by peeling off the adhesive film for masking a radiation image conversion panel was formed.

### Comparative Example 1

Sheets were prepared through the same cutting process as in Example 1. A polyester resin layer with an average thickness of 3 μm was formed by coating a polyester resin on the phosphor layer on the surface that had not been laminated (the surface not contacting the substrate) by a dip method to manufacture a radiation image conversion panel.

Evaluation of Water Resistance

The radiation image conversion panel was hermetically sealed in a bag while a sheet of filter paper (square shape of 3.5 cm×3.5 cm) impregnated with distilled water was made to contact the panel so as to cover the radiation image conversion panel. After allowing to stand for 24 hours at 30° C., moisture on the surface of the radiation image conversion panel was wiped off and, after drying, the panel was exposed to X-rays with an intensity of 10 mR. The image on the panel after exposure was read with a reading scanner of the radiation image conversion panel, and the signal from the conversion panel was outputted on a film at an image density of 1.2. After output on the film, film showing no desensitization (uneven image) at the position corresponding to the periphery of the radiation image conversion panel was evaluated as “A”, film showing slight desensitization, but not a problem in practice, was evaluated as “B”, and the film showing desensitization with practical problems was evaluated as “X”. The results are shown in Table 1 below.

TABLE 1

| | Water resistance |
|---|---|
| Example 1 | A |
| Example 2 | A |
| Example 3 | A |
| Example 4 | A |
| Example 5 | B |
| Comparative example 1 | X |

Table 1 shows that the radiation image conversion panels in Examples 1 to 5 were excellent in water resistance, although the panel in Comparative Example 1 had low water resistance. The panels in examples were confirmed to be excellent in durability to adhered water drops. The radiation image conversion panels in Examples 1 to 4 on which the coating layer was formed by CVD showed a better water resistance than the radiation image conversion panel in Example 5, since particularly dense films (specifically films with fewer cracks, cleaves and point defects) were formed in the panels in Examples 1 to 4.

### CROSS-REFERENCE TO RELATED APPLICATION

This application claims priority under 35 USC 119 from Japanese Patent Application No. 2005-272829, the disclosure of which is incorporated by reference herein.

What is claimed is:

1. A radiation image conversion panel having a substrate and a phosphor layer laminated on the substrate, wherein a coating layer having at least one metal containing-layer is provided on a surface of the phosphor layer which is other than on the side which the substrate is laminated.

2. The radiation image conversion panel of claim 1, wherein the metal-containing layer comprises at least one of a metal oxide or a metal nitride.

3. The radiation image conversion panel of claim 1, wherein the metal-containing layer comprises at least one of silicon oxide, silicon nitride, silicon oxide nitride and aluminum oxide.

4. The radiation image conversion panel of claim 1, wherein the coating layer comprises the metal-containing layer and a resin layer, and the resin layer and the metal-containing layer are sequentially formed in this order on a surface of the phosphor layer which is other than on the side which the substrate is laminated.

5. The radiation image conversion panel of claim 2, wherein the coating layer comprises the metal-containing layer and a resin layer, and the resin layer and the metal-containing layer are sequentially formed in this order on a surface of the phosphor layer which is other than on the side which the substrate is laminated.

6. The radiation image conversion panel of claim 3, wherein the coating layer comprises the metal-containing layer and a resin layer, and the resin layer and the metal-containing layer are sequentially formed in this order on a surface of the phosphor layer which is other than on the side which the substrate is laminated.

7. The radiation image conversion panel of claim 1, wherein the metal-containing layer is formed by a CVD method.

8. The radiation image conversion panel of claim 7, wherein the CVD method is a plasma CVD method.

9. A method for forming a radiation image conversion panel having a substrate and a phosphor layer laminated on the substrate, comprising forming, by a CVD method, a metal containing-layer on a surface of the phosphor layer which is other than on the side which the substrate is laminated.

10. The method of claim 9, wherein the metal containing-layer is formed at a single time on the entire surface of the phosphor layer which is other than on the side which the substrate is laminated.

11. The method of claim 9, wherein the metal-containing layer comprises at least one of a metal oxide or a metal nitride.

12. The method of claim 9, wherein the metal-containing layer comprises at least one of silicon oxide, silicon nitride, silicon oxide nitride or aluminum oxide.

13. The method of claim 9, wherein the coating layer comprises the metal-containing layer and a resin layer, and the resin layer and the metal-containing layer are sequentially formed in this order on a surface of the phosphor layer which is other than on the side which the substrate is laminated.
